(19) United States
(12) Patent Application Publication
(10) Pub. No.: US 2023/0401322 A1
(43) Pub. Date: Dec. 14, 2023

(54) METHOD FOR REMEDIATING VULNERABILITIES OF A DATA PROCESSING SYSTEM

(71) Applicant: Robert Bosch GmbH, Stuttgart (DE)

(72) Inventor: Paulius Duplys, Markgroeningen (DE)

(21) Appl. No.: 18/326,833

(22) Filed: May 31, 2023

(30) Foreign Application Priority Data
Jun. 8, 2022 (DE) 10 2022 205 838.0

(51) Int. Cl. G06F 21/57; G06F 21/55

(52) U.S. Cl. CPC G06F 21/577; G06F 21/554; G06F 21/552

(57) ABSTRACT

A method for remediating vulnerabilities of a data processing system. The method includes: storing a vulnerability response rule set which specifies responses of the data processing system in the data processing system, wherein each response is associated with one or more conditions and one or more functions of the data processing system, for each condition, it depends on the data processing system and a vulnerability or both, whether the condition is met; receiving a notification about a vulnerability of the data processing system; ascertaining one or more responses from the vulnerability response rule set, such that, for each ascertained response, the one or more conditions with which the ascertained response is associated are met for the vulnerability and the data processing system and the ascertained response is associated with at least one function to which the vulnerability relates and carrying out the one or more ascertained responses.

### CROSS REFERENCE

The present application claims the benefit under 35 U.S.C. § 119 of German Patent Application No. DE 10 2022 205 838.0 filed on Jun. 8, 2022, which is expressly incorporated herein by reference in its entirety.

### FIELD

The present invention relates to methods for remediating vulnerabilities of a data processing system.

### BACKGROUND INFORMATION

Networked embedded systems are used for safety-related applications, e.g., the control of vehicles. Because they are networked, i.e., connected to external networks, e.g., the Internet, they are exposed to attacks which, depending on the application, can have serious consequences, such as accidents in which people are injured. It is therefore important that vulnerabilities in software for embedded systems are eliminated. This is typically accomplished with a patch that is implemented and distributed to the affected embedded systems when a vulnerability is discovered and reported.

For networked embedded systems in safety-related applications, however, the “report vulnerability->implement patch->distribute patch” cycle is too slow to reliably mitigate the risk, for example of traffic accidents. Mechanisms to be able to react quickly to a newly found security flaw are therefore desirable.

### SUMMARY

A method for remediating vulnerabilities of a data processing system is provided with the aid of various embodiments of the present invention, wherein the method comprises: storing a vulnerability response rule set which specifies responses of the data processing system in the data processing system, wherein each response is associated with one or more conditions and one or more functions of the data processing system, wherein, for each condition, it depends on the data processing system and a vulnerability or both, whether the condition is met; receiving a notification about a vulnerability of the data processing system; ascertaining one or more responses from the vulnerability response rule set, such that, for each ascertained response, the one or more conditions with which the ascertained response is associated are met for the vulnerability and the data processing system and the ascertained response is associated with at least one function to which the vulnerability relates and carrying out the one or more ascertained responses.

The above-described method enables a quick response to a vulnerability in a software i.e. a security flaw.

Various embodiment examples of the present invention are provided in the following.

Embodiment example 1 is a method for remediating vulnerabilities of a data processing system as described above.

Embodiment example 2 is the method according to embodiment example 1, wherein each of at least some of the conditions is that a function associated with the condition is available in the data processing system.

It is thus possible to quickly discard responses because they relate to vulnerabilities of a function or subfunctions of said function that are not available on the data processing system.

Embodiment example 3 is the method according to embodiment example 1 or 2, wherein the vulnerability response rule set is hierarchically structured so that, starting from one or more functions of the data processing system, paths to the responses are included, which comprise one or more subfunctions, wherein each subfunction is a subfunction of the function or subfunction preceding it in the path, and one or more conditions.

In other words, the responses are organized like leaves in a tree structure, wherein the nodes above the leaves correspond to conditions, subfunctions and functions. This makes it possible to efficiently ascertain (i.e. find) responses, because there is no need to search subtrees of the tree if they emanate from a node that corresponds to a condition that is not met.

A response is associated with the (sub)functions and conditions contained in the path from a root node of the tree structure to the response.

Embodiment example 4 is the method according to any one of embodiment examples 1 to 3, wherein each of at least some of the conditions is that no protection program is available for a function associated with the condition.

This avoids responses being carried out when the data processing system is already protected from the vulnerability by a respective protection program.

Embodiment example 5 is the method according to any one of embodiment examples 1 to 4, wherein the data processing system is an embedded system for controlling a robot device.

In such cases in particular, a quick response to vulnerabilities is often urgently required. The above-described method enables a quick response to vulnerabilities. This only requires transmitting a report of the vulnerability to the embedded system (and not a full software update). The vulnerability can in particular be eliminated in the field and the software update can be postponed (and carried out in a workshop, for example.)

Embodiment example 6 is a data processing system configured to carry out a method according to any one of embodiment examples 1 to 5.

Embodiment example 7 is a computer program comprising instructions that, when executed by a processor, cause said processor to carry out a method according to any one of embodiment examples 1 to 5.

Embodiment example 8 is a computer-readable medium which stores instructions that, when executed by a processor, cause said processor to carry out a method according to any one of embodiment examples 1 to 5.

In the figures, like reference signs generally refer to the same parts throughout the different views. The figures are not necessarily to scale, wherein emphasis is instead generally placed on representing the principles of the present invention. In the following description, various aspects of the present invention are described with reference to the figures.

### BRIEF DESCRIPTION OF THE DRAWINGS

FIG. 1 shows a vehicle 101, according to an example embodiment of the present invention.

FIG. 2 illustrates the mechanism for remediating a vulnerability according to one embodiment of the present invention using the abovementioned components.

FIG. 3 shows a (game) tree structure 300 of a (vulnerability response) rule set 204, according to one example embodiment of the present invention.

FIG. 4 shows a flowchart depicting a method for remediating vulnerabilities of a data processing system according to one embodiment.

### DETAILED DESCRIPTION OF EXAMPLE EMBODIMENTS

The following detailed description relates to the accompanying figures, which, for clarification, show specific details and aspects of this disclosure in which the present invention can be implemented. Other aspects can be used, and structural, logical, and electrical changes can be carried out without departing from the scope of protection of the present invention. The various aspects of this disclosure are not necessarily mutually exclusive since some aspects of this disclosure can be combined with one or more other aspects of this disclosure to form new aspects of the present invention.

Various examples will be described in more detail in the following.

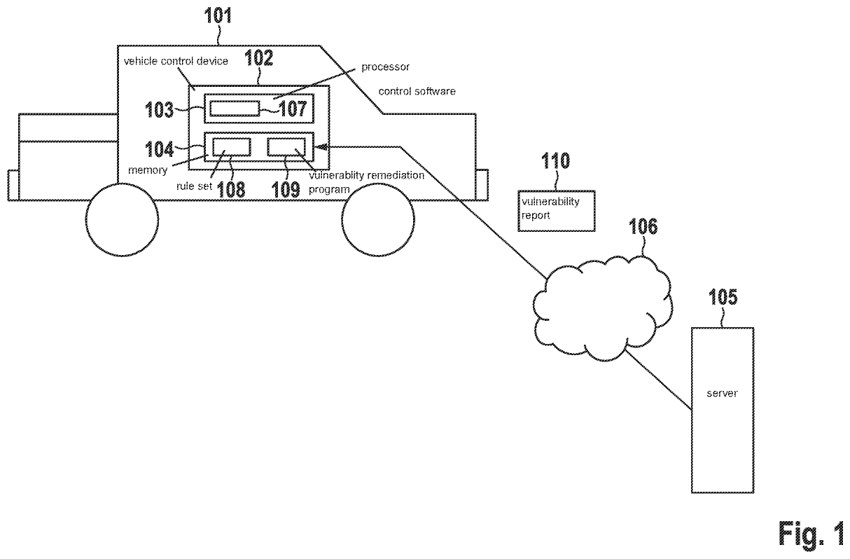

FIG. 1 shows a vehicle 101.

In the example of FIG. 1, a vehicle 101, for example a car or truck, is provided with a vehicle control device 102.

The vehicle control device 102 comprises data processing components, e.g., one or more processors (e.g., one or more CPUs (central processing unit) or microcontrollers) 103 and one or more memories 104 for storing control software 107 according to which the vehicle control device 102 operates, and data that are processed by the processor 103.

The stored control software (computer program) comprises instructions, for example, that, when executed by the processor, cause the processor 103 to carry out driver assistance functions (or also to collect driving data) or to even control the vehicle autonomously.

The vehicle control device 102 is an embedded system, in this example in a vehicle. However, this is only one example, and the vehicle control device 102 can be used in any type of robot device, e.g. in an Industry 4.0 machine. Such an embedded system (vehicle control device 102) can also be distributed, i.e. implemented by multiple data processing devices (in the case of a vehicle, multiple ECUs (electronic control units)) that are connected to one another. It can also be networked with external components, in this example with a server 105 via a network 106. The vehicle control device 102 can therefore be a networked embedded system.

Due to the combination of their ever-increasing complexity (primarily due to the software 107 they run) and their connectivity to the outside (here to the server 105), networked embedded systems, such as such a control system of a vehicle or other robot device, are exposed to attacks from outside. Because cyber attacks on such embedded systems can easily cause malfunctions that lead to physical harm, solutions are needed to respond to security vulnerabilities before they are exploited.

In the currently prevailing IT security paradigm, security vulnerabilities are typically first reported to the respective software project or device manufacturer (e.g. via the PSIRT (Product Security Incident Response Team) of the manufacturer) and, after a reasonable period of time (typically up to six months), cataloged as CVEs (common vulnerabilities and exposures) for public disclosure in a CVE system, e.g. of MITRE. During this time, the software project or device manufacturer is expected to implement a patch for this security flaw and make the patch available to the public (e.g. in the case of an open source software project) or distribute it to all devices in the field that are affected by the security flaw (in the case of a specific product).

For networked embedded systems, the “report vulnerability->implement patch->distribute patch” cycle is too slow. Many embedded systems, for instance, rely heavily on open source software or commercial third-party components (such as libraries or frameworks). Between the discovery of the vulnerability and the availability of the patch, the affected systems are susceptible to attacks. Also, during this period of time, a product manufacturer has no control over who knows about the vulnerability and how quickly the patch will be available.

Therefore, according to various embodiments, a mechanism is provided that enables networked embedded systems to respond immediately to a security flaw that becomes known to it through a CVE system or through a message to the product manufacturer (in the example of FIG. 1, for instance, communicated by the server 105 of the control device 102).

For this purpose, according to various embodiments, it is provided that a vulnerability response rule set 108 (or “handbook”) comprising executable actions for remediating vulnerabilities is stored on the respective embedded system to be protected (in the present example, the vehicle control device 102), and that a monitoring or vulnerability remediation device (implemented here by a vulnerability remediation program 109) is provided, which carries out respective actions of the (vulnerability response) rule set in the event of a vulnerability detection (here the receipt of a notification 110 about a vulnerability, i.e. a vulnerability report 110, from the server 105).

According to various embodiments of the present invention, the rule set 108 has a (game) tree-like structure for easy navigation through the rule set, and includes descriptions of executable actions that can be used to respond to respective reported vulnerabilities, e.g. by disabling specific functions or by a graceful degradation of specific system components.

The embedded system 102 receives messages about newly discovered vulnerabilities (e.g., from the server 105 via the network 106) via at least one special, properly secured API (application programming interface) in the form of a vulnerability report 110. The vulnerability report 110 originates from a public system such as MITRE's CVE program or from the product manufacturer (i.e., the manufacturer of the embedded system 102 or the vehicle 101).

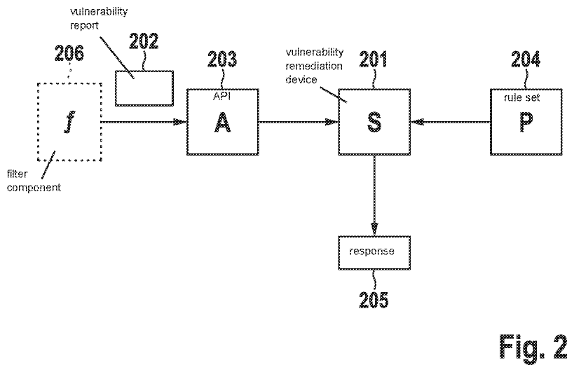

FIG. 2 illustrates the mechanism for remediating a vulnerability according to one embodiment using the abovementioned components.

A vulnerability remediation device 201 receives a vulnerability report 202 via an API 203. Using information from a (vulnerability response) rule set 204, the vulnerability remediation device 201 generates a response 205 to a vulnerability reported by the vulnerability report 202. This means that the vulnerability remediation device 201 assesses the vulnerability according to the definitions in the (vulnerability response) rule set 204 and carries out the response (action) encoded in the rule set 204 for that specific vulnerability.

Multiple APIs 203, e.g., to different external data processing devices, can be provided to receive vulnerability reports 202 about newly discovered vulnerabilities (e.g., CVE reports).

Vulnerability reports can optionally be prefiltered such that the vulnerability reports 202 delivered to the vulnerability remediation device 201 are only notifications of vulnerabilities in specific software packages or vulnerabilities that meet one or more other suitable filtering conditions, e.g., so that a vulnerability report 201 for a software package X is forwarded to the vulnerability remediation device 201 only if the feature Y is actually enabled on the device in question. This filtering can be carried out externally (e.g., by the server 105) or locally by a filter component 206 of the embedded system 102.

The vulnerability remediation device 201 accepts incoming vulnerability reports 202 (i.e., notifications or messages about vulnerabilities) and accesses the vulnerability response rule set 204, which is executable in the sense that it contains executable actions, and assesses each vulnerability message or responds to each vulnerability message based on the instructions included in the rule set 204 (in particular instructions to carry out specific actions in response to vulnerabilities).

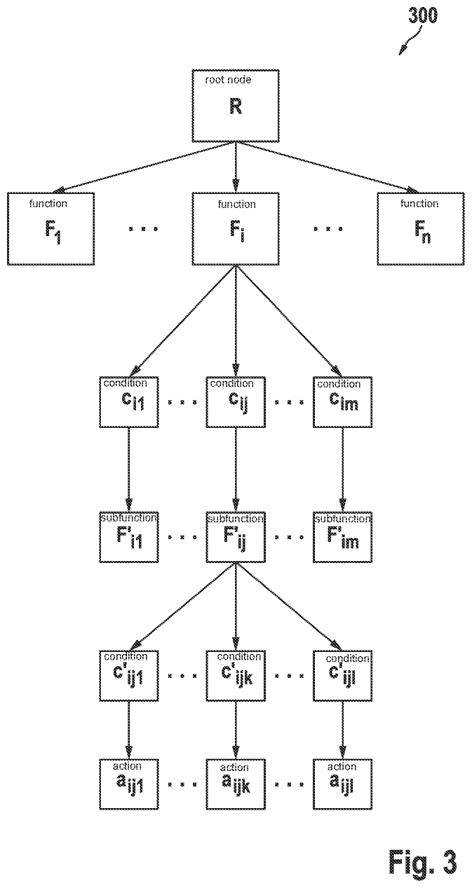

FIG. 3 shows a (game) tree structure 300 of a (vulnerability response) rule set 204, according to one embodiment.

In the vulnerability response tree structure 300, each node includes one or more key-value pairs that describe a respective function, subfunction, component, property or action to be carried out of the embedded system.

This format is extensible, i.e., the vulnerability remediation device 201 can be extended at any time by processing additional key-value pairs.

The root node R refers to a finite number of functions or functionalities Fᵢ that are included in and implemented by the respective embedded system. These can be components of the top-level architecture of the embedded system, for example. In the case of a vehicle, this would be engine control, multimedia, connectivity, brakes for instance (the GENIVI Vehicle Signal Specification, for example, can be used to define them).

Each function Fᵢ is associated with a set of conditions cᵢⱼ, wherein the condition cᵢⱼ is assigned to the jth child node of the node to which the function Fᵢ is assigned.

The conditions can correspond to subfunctions F′ᵢⱼ of Fᵢ, for instance, that are either enabled or disabled on the respective embedded system; i.e. a condition cᵢⱼ is, for example, that a respective subfunction F′ᵢⱼ of Fᵢ is available or enabled on the embedded system.

Depending on the type of function Fᵢ of which they are subfunctions, the F′ᵢⱼ subfunctions are, for instance, subfunctions of a central control of the vehicle, subfunctions of the engine control, subfunctions of the telematics, etc.

The key-value pairs contained in a node assigned to a function or subfunction identify one or more subfunctions (or subfunctionalities) such as software components, libraries and classes (including their version number) that can be used to implement the function or subfunction of which the node is a child node on the embedded system.

Any subfunction (or subfunctionality) F′ᵢⱼ can be associated with conditions c′ᵢⱼₖ. The conditions could, for instance, depend on how the specific software components, libraries or classes (of the child nodes of F′ᵢⱼ) are used and relate to the embedded system or the vulnerability (e.g. a condition is that a subfunction has to use a specific library function for a specific vulnerability in a specific manner).

For example, c′ᵢⱼₖ could require that a specific library function (with index k) be used to implement F′ᵢⱼ, or that there is no sanitizer subprogram (i.e. a protection program) that wraps those functions to eliminate unexpected inputs.

This hierarchical structure can extend further, i.e. for the subfunctions F′ᵢⱼ there can in turn be subfunctions, which in turn are associated with nodes that are assigned conditions and have lower-level nodes.

In this example, however, it is assumed for the sake of simplicity that no further subfunctions are considered for the subfunctions F′ᵢⱼ themselves (i.e. they form the lowest layer of subfunctions). The conditions c′ᵢⱼₖ associated with the F′ᵢⱼ function then refer directly to action nodes with actions aᵢⱼₖ The vulnerability remediation device 201 carries out an action if all conditions on the path from the root R to it are met.

Thus, for a reported vulnerability, the vulnerability remediation device 201 runs through the tree structure of the rule set and carries out every action it reaches by way of a path through the tree structure for which
the path contains at least one node assigned to the function or subfunction for which the vulnerability exists (as specified in the vulnerability report)
all conditions in the path are met (the subfunction is available, a respective sanitizer program is not available, etc.)

Each action node contains an executable description of the respective response to the vulnerability. Generally speaking, the description is a collection of shell commands, e.g. for updating specific software packages, reconfiguring specific software packages to disable selected functions, closing ports or disabling specific operating system services and protocols, adding filters to user-provided inputs, or turning specific functions off completely.

The vulnerability remediation device 201 that processes the rule set in the above-described manner and, if necessary, carries out actions is a special program, for example, that can interpret (e.g., accordingly parse and analyze) the rule set in the above-described manner and carry out the actions (e.g., commands) defined in a on the operating system of the embedded device.

The functionality of the vulnerability remediation device 201 required for this is not complex, because every condition node in the rule set simply forms a logical expression that it evaluates and can carry out any action, e.g., using an exec( ) system call (or a corresponding equivalent in the respective programming language, such as Python, Rust, Ruby, etc.).

Examples of vulnerabilities that can be reported to the embedded system are
1) a vulnerability in the tire pressure monitoring system (TPMS)
2) a vulnerability in the logging system (e.g., Log4J)
3) a vulnerability in the implementation of the HSM (hardware security module) signature verification algorithm

Examples of associated conditions are
1) the TPMS is available
2) Log4J is being used in the software of the main unit of the vehicle
3) the HSM uses a specific signature verification algorithm in this vehicle (which has the vulnerability)

Examples of associated actions are
1) (if the TPMS is available) ignore suspicious readings
2) (if Log4J is being used) turn logging off
3) (if the HSM is using the specific signature verification algorithm) temporarily disable remote software updating (e.g. updating is allowed only in a workshop).

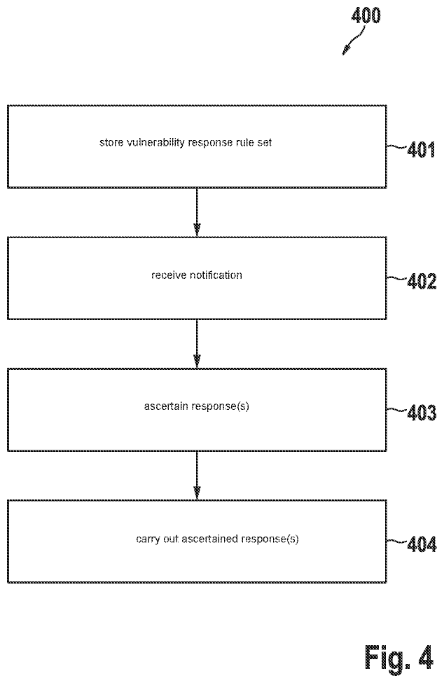

In summary, a method is provided according to various embodiments, as shown in FIG. 4.

FIG. 4 shows a flowchart 400 depicting a method for remediating vulnerabilities of a data processing system according to one embodiment.

In 401, a vulnerability response rule set that specifies responses of the data processing system is stored in the data processing system, wherein each response is associated with one or more conditions and one or more functions of the data processing system, wherein, for each condition of the data processing system and a vulnerability or both, it depends on whether or not said condition is met.

In 402, a notification about a vulnerability of the data processing system is received.

In 403, one or more responses are ascertained from the vulnerability response rule set such that, for each ascertained response, the one or more conditions with which the ascertained response is associated are met for the vulnerability and the data processing system and the ascertained response is associated with at least one function to which the vulnerability relates.

In 404, the one or more ascertained responses are carried out.

The one or more functions can include a function and one or more subfunctions thereof, in particular a chain of functions, wherein, starting from one function, the next following function is a subfunction of the preceding function.

The method of FIG. 4 can be carried out by one or more computers comprising one or more data processing units. The term “data processing unit” can be understood to mean any type of entity that enables the processing of data or signals. The data or signals can, for example, be processed according to at least one (i.e., one or more than one) specific function carried out by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the respective functions described in more detail here can also be understood as a data processing unit or logic circuitry. One or more of the method steps described in detail here can be carried out (e.g. implemented) by a data processing unit by means of one or more specific functions executed by the data processing unit.

The data processing system is a control device (or control system) for a robot device, for instance. The term “robot device” can be understood to mean any technical system (comprising a mechanical part the movement of which is controlled), such as a computer-controlled machine, a vehicle, a household appliance, a power tool, a manufacturing machine, a personal assistant or an access control system.

Various embodiments can receive and use sensor signals from various sensors, such as video, radar, LiDAR, ultrasound, motion, thermal imaging, etc.

Although specific embodiments have been illustrated and described here, those skilled in the art in the field will recognize that the specific embodiments shown and described may be exchanged for a variety of alternative and/or equivalent implementations without departing from the scope of protection of the present invention. This application is intended to cover any adaptations or variations of the specific embodiments discussed here.

What is claimed is:

1. A method for remediating vulnerabilities of a data processing system, the method comprising the following steps:
storing a vulnerability response rule set which specifies responses of the data processing system in the data processing system, wherein each of the responses is associated with one or more conditions and one or more functions of the data processing system, wherein, for each condition, whether the condition is met depends on the data processing system and a vulnerability or both;
receiving a notification about a vulnerability of the data processing system;
ascertaining one or more responses from the vulnerability response rule set, such that, for each ascertained response, the one or more conditions with which the ascertained response is associated are met for the vulnerability and the data processing system and the ascertained response is associated with at least one function to which the vulnerability relates; and
carrying out the one or more ascertained responses.

2. The method according to claim 1, wherein each of at least some of the conditions is that a function associated with the condition is available in the data processing system.

3. The method according to claim 1, wherein the vulnerability response rule set is hierarchically structured so that, starting from one or more functions of the data processing system, paths to the responses are included, which include one or more subfunctions, wherein each subfunction is a subfunction of the function or subfunction preceding it in the path, and one or more conditions.

4. The method according to claim 1, wherein each of at least some of the conditions is that no protection program is available for a function associated with the condition.

5. The method according to claim 1, wherein the data processing system is an embedded system for controlling a robot device.

6. A data processing system configured to remediate vulnerabilities of the data processing system, the data processing system configured to:
store a vulnerability response rule set which specifies responses of the data processing system in the data processing system, wherein each of the responses is associated with one or more conditions and one or more functions of the data processing system, wherein, for each condition, whether the condition is met depends on the data processing system and a vulnerability or both;
receive a notification about a vulnerability of the data processing system;
ascertain one or more responses from the vulnerability response rule set, such that, for each ascertained response, the one or more conditions with which the ascertained response is associated are met for the vulnerability and the data processing system and the ascertained response is associated with at least one function to which the vulnerability relates; and
carry out the one or more ascertained responses.

7. A non-transitory computer-readable medium on which is stored a computer program including instructions for remediating vulnerabilities of a data processing system, the instructions, when executed by a processor, causing the processor to perform the following steps:
storing a vulnerability response rule set which specifies responses of the data processing system in the data processing system, wherein each of the responses is associated with one or more conditions and one or more functions of the data processing system, wherein, for each condition, whether the condition is met depends on the data processing system and a vulnerability or both;
receiving a notification about a vulnerability of the data processing system;
ascertaining one or more responses from the vulnerability response rule set, such that, for each ascertained response, the one or more conditions with which the ascertained response is associated are met for the vulnerability and the data processing system and the ascertained response is associated with at least one function to which the vulnerability relates; and
carrying out the one or more ascertained responses.
